(19) United States
(12) Patent Application Publication
(10) Pub. No.: US 2004/0236586 A1
(43) Pub. Date: Nov. 25, 2004

(54) Method and system for standardizing the quality of materials and services used in structured cabling networks

(75) Inventor: Richard J. Hirshkind JR., Port Jefferson Station, NY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ

(21) Appl. No.: 10/443,942

(22) Filed: May 22, 2003

(51) Int. Cl. G06F 17/60

(52) U.S. Cl. 705/1

(57) ABSTRACT

Uniform quality standards are applied to materials and workers provided for structured cabling networks such as home automation networks, distributed audio networks, distributed video networks, telephone networks, computer networks, lighting networks, security networks, fire safety networks, and climate control networks, in residences and light commercial buildings. Materials from different suppliers are tested and certified based on the uniform standards. Workers are also tested and certified in areas including installation and design. The certified materials and certified workers are offered to builders, homeowners and others under a brand name that is associated with the uniform quality standards to ensure good results.

### BACKGROUND OF THE INVENTION

1. Field of Invention

The invention relates generally to the field of structured cabling networks, such as in-home automation networks and computer networks, and, more specifically, to a method and system for standardizing the delivery of such networks.

2. Description of Related Art

Buildings such as light commercial buildings and residences of every type are becoming increasingly automated and packed with electronics. Features such as computer networks, home theater and other audio/video networks, and security system networks are being installed at a growing rate in both new construction and retrofit applications. In fact, recent statistics show that about 30% of new homes have such networks. A related fact is that home networking sales are expected to reach $11 billion for 2003. To provide such features, materials such as cables, outlets, control devices and other electronic equipment must be unobtrusively installed in the building, typically including within walls, ceilings or other concealed locations. Such networks are generally referred to as structured cabling networks. Moreover, the cabling is typically low-voltage, as opposed to high voltage (e.g., 120 or 220 Volt) electrical service wiring.

The installation of such cabling networks must meet building requirements such as local and national building codes, as well as allowing future maintenance and upgrading. For new construction, efficiencies can be achieved by coordinating the installation of the networks with the construction of the building. For example, wiring for speakers for a home theater can be installed in walls and ceilings before the finishing materials, such as drywall, are installed. Retrofit, e.g., remodel, applications must also be carefully planned to minimize disruption to the existing building structure and its occupants.

However, the quality of the resulting cabling network can vary due to the varying quality of the materials used and the varying techniques and expertise employed by the workers that design, sell, install, and maintain the networks. Similarly, the degree to which the homeowner, builder, building owner or lessee or other party is able to make an informed buying decision can vary based on their knowledge of such networks, the information that the workers communicate with them, and the brand names of the materials used. For example, residential homebuilders and buyers are often not well versed with cabling networks and may select materials, suppliers and installers based solely on a low price, resulting in an inferior result. Moreover, manufacturers and other suppliers of materials used in the networks are not assured that their materials are used appropriately. Improper selection, installation, or maintenance of the materials may make warranty claims problematic while also damaging the reputation of the supplier. Damage to the building or materials, or even risk of injury such as electric shock, may also result. Liability issues are also a concern, e.g., due to an improperly installed fire or burglar/security alarm system.

While some companies offer training specific to their materials, there has heretofore not been an effective way to offer a choice of certified materials and workers to builders, home buyers, homeowners and others in the residential and light commercial structured cabling network market.

### BRIEF SUMMARY OF THE INVENTION

To overcome these and other deficiencies in the prior art, the present invention describes a method and system for standardizing the delivery of structured cabling networks.

In one aspect of the invention, a method for providing structured cabling networks in buildings in accordance with uniform quality standards includes defining uniform quality standards for materials for use in the structured cabling networks, and for workers for the structured cabling networks. The uniform quality standards are provided to a testing facility for use in certifying materials that are available from suppliers and certifying workers that are available to provide services. The testing facility tests the materials and workers to determine if they meet predetermined criteria under the uniform standards, and, if they do, they are certified as such. The certified materials and certified workers are offered for use in providing the structured cabling networks. For example, they may be offered to a homebuilder or a homeowner.

In another aspect of the invention, a system for providing structured cabling networks in buildings in accordance with uniform quality standards is disclosed. The system includes at least one database for storing information regarding certified materials that are provided by suppliers for use in the structured cabling networks, and regarding certified workers that are available to provide services for the structured cabling networks using the certified materials; such as design and installation. The materials and workers are certified based on testing that indicates they meet predetermined criteria under the uniform quality standards.

In another aspect of the invention, a method for providing materials and workers for structured cabling networks in buildings in accordance with uniform quality standards includes: (a) certifying materials for use in the structured cabling networks that are available from different suppliers based on testing that indicates the materials meet first predetermined criteria under uniform quality standards, and (b) certifying workers that are available to provide services for the structured cabling networks based on testing that indicates the workers meet second predetermined criteria under the uniform quality standards. Information is provided for offering the certified materials and certified workers for use in providing the structured cabling networks. For example, the information may include data regarding the certified materials and workers that is stored in a database and accessible by network integrators, builders, home owners and others.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a system for standardizing the quality of materials and services used in structured cabling networks; and

FIG. 2 illustrates a method for standardizing the quality of materials and services used in structured cabling networks.

### DETAILED DESCRIPTION OF THE INVENTION

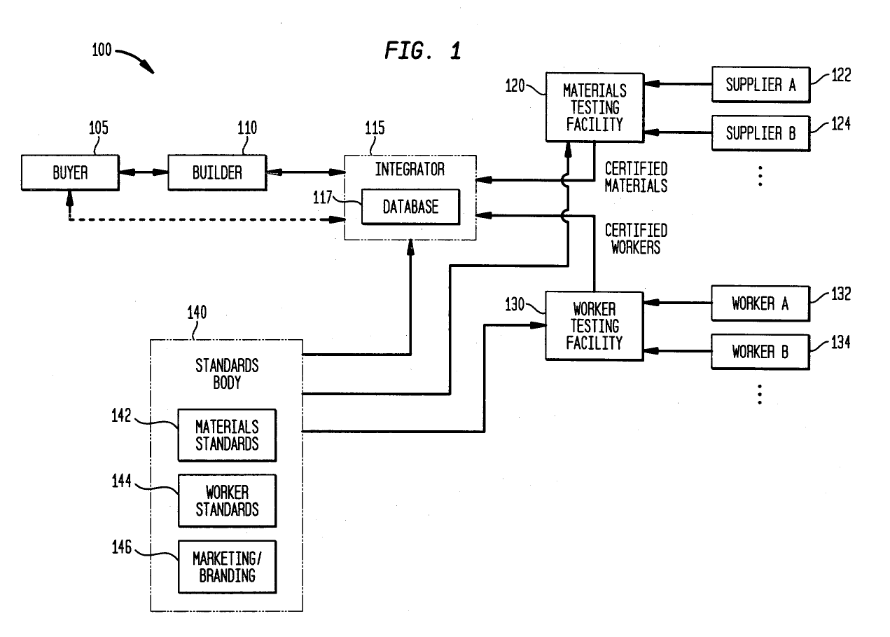

FIG. 1 provides an overview of a system for providing certified materials and workers for structured cabling networks according to the invention. The parties involved in the system may include a standards body 140, which develops uniform materials standards 142, worker standards 144, and marketing and branding 146 for promoting the certified materials and workers. Marketing includes advertisements and promotions that are made, such as by using expos, direct mail, web and targeted advertising, builder tradeshows and other marketing vehicles. Branding includes trademarks and service marks that identify the certified materials and workers. The branding serves as an indication of quality and performance.

A systems integrator 115 may be a human and/or automated resource, that accesses a database 117 to provide information regarding the certified materials, workers and standards to a builder 110 and/or a homebuyer 105. Generally, it is expected that the integrator will work primarily with the builder 110, although direct communication with the buyer 105 is possible. The systems integrator 115 is a professional that plays a key role in the sales, design and installation process for the structured cabling market. The integrator 115 may be independent or associated with the standards body 140, for example. Working in the new construction, retrofit and aftermarket arenas, the integrator specialist is inundated with new products, new solutions and new offerings in the consumer electronic sales category. Conventionally, channel providers, e.g., suppliers, offer a multitude of electronic solutions, often with little research into product durability and quality. To solve this problem, the invention assists professional integrators who are searching for quality and professional solutions that offer reliability, performance and meet key industry standards. The invention offers a solution by leveraging an objective, respected quality verification process for materials and workers to ensure that the integrators are provided a range of consumer electronic products and services for structured cabling networks that are tested and proven to perform.

To this end, a materials testing facility 120 receives the uniform materials standards from the standards body 140 for use in testing materials provided by different suppliers, such as suppliers 122 and 124. The materials that meet predetermined criteria as set forth in the materials standards are certified by the materials testing facility 120, and the associated information is provided for storage in the database 117 and subsequent use. Similarly, a worker testing facility 130 receives the uniform worker standards from the standards body 140 for use in testing workers, such as workers 132 and 134. The workers that meet predetermined criteria as set forth in the workers standards are certified by the worker testing facility 130, and the associated information is likewise provided for storage in the database 117 and subsequent use.

The materials that may be tested include essentially any materials that can be used to provide a structured cabling network. This includes materials that are used in the network itself, such as cabling, outlets and control devices, and hardware for securing them to the structure. The cabling may include optical fiber and copper wiring, including unshielded twisted pair, shielded twisted pair and coaxial. The outlets, or jacks, may include phone, television and universal jacks. The control devices may include switches, dials, keypads, control panels, and the like that are used to control equipment in the different types of structured cabling networks. This equipment may include lights, speakers, cameras, audio and video receivers and players, computers, heat or air conditioning units, fire and burglar alarm sensors, motors for adjusting draperies and skylights, central vacuum systems and so forth. The control devices may be human operable and/or automated. The materials may also include equipment that is not used in the network itself. This may include, e.g., test equipment for testing the network or its components, as well as equipment used in the installation, including demolition equipment, such as saws, drills and the like, equipment for feeding cables through walls and other inaccessible locations, and equipment for restoring or otherwise concealing any damaged areas of the structure. This may include drywall repair tools, patching materials and the like.

The workers may include any persons who are interested in installing and designing structured cabling networks. The workers may communicate with the builder 110 and home buyer 105, and should therefore have a good knowledge of design and installation considerations, as well as knowledge of the materials and suppliers. The workers may also act as sales persons and should therefore have knowledge of various costs to the builder 110 and buyer 105 for materials and services, as well as information regarding timing of different phases of the installation with a new construction or retrofit application. Once certified, the workers may be required to periodically attend continuing education classes to maintain their certifications. Note that the workers may be independent contractors, employees of a labor supply firm, or the like.

The certified materials and the certified workers may be offered for use in providing the structured cabling networks in accordance with a brand name that is associated with the uniform quality standards. This enables builders, homebuyers, and others to know that they can expect to receive materials and services that meet quality standards. As in other areas of commerce, a brand name, e.g., trademark or service mark, designates the source of goods and services and can serve as a useful tool to buyers. Moreover, buyers are often willing to pay more for goods and services that are associated with a well-known brand.

The materials testing facility 120 and worker testing facility 130 may be operated by a common entity or different entities. Moreover, one or more of each type of facility may be provided. Generally, it is desirable for the materials testing facility 120 to be substantially independent from the suppliers 122 and 124, and for the workers testing facility 130 to be substantially independent from the workers, to avoid undue conflicts of interest. An independent testing laboratory such as Underwriters Laboratories (UL) Inc. may be used, for instance. UL is an independent, not-for-profit product safety testing and certification organization, which also provides training courses. The worker testing facility 130 may be also implemented by any of various training facilities, such as vocational schools, trade groups, and the like. All or a portion of the training may occur via computer-based distance learning as well, although some hands on training is expected to be helpful, at least for the workers' initial training. The testing may cover different areas or modules, including materials, design and installation. These areas may be broken down into more specific categories, such as security systems, voice systems, data distribution, video distribution, lighting control and the like. For example, a worker may be trained in areas such as selection and installation of speaker wire and thermostat controls. A worker may be tested on providing a design layout for a home theater system, e.g., including locations and materials for wiring, speakers, screen and so forth, and for different room configurations and construction types. Workers may also indicate geographic areas in which they are willing to make themselves available. Workers may further be certified as to their experience and expertise level, e.g., trainee, journeyman, master, crew manager, project manager, and so forth.

Furthermore, testing and certifying may be tailored to specific concerns in a geographic area, such as local building codes, and specific features of cabling networks that are of particular concern in the area. For example, specific installation issues arise based on the home construction type, which can differ in different geographic regions. To illustrate, concrete block construction homes are common in the South, while homes with basements are common in cold weather climates, and homes with crawl spaces are common in moderate climates. Homes with brick or stone facades may also pose special concerns. Different strategies for installing cables may apply in each case. Moreover, training, testing and certifying may be tailored to different types of buildings, including residences and light commercial buildings. Residences include single-family unattached homes, single family attached homes such as townhouses, multi-family homes, apartments, and so forth. Light commercial buildings include buildings that house restaurants, shops, schools, small offices, convenience stores or other small businesses and services. Materials may also be tested and certified according to building type and other factors. Furthermore, specific types of structured cabling networks may be more common in certain areas, e.g., climate control automation networks in areas with extreme temperatures, burglar alarm networks in areas where crime is a concern, and so forth.

In one possible approach, the standards body 140 is provided by a party that is involved in providing structured cabling networks materials and services. This party may be a company that provides materials and/or workers for use in the networks. However, the materials and/or worker testing facilities 120 and 130, respectively, are preferably substantially independent from the company or other entity 140 that defines the uniform quality standards to avoid the appearance of an undue conflict of interest. To further the industry as a whole as well as its own interests, the standards body 140 may choose certain suppliers, workers, integrators or associated entities to partner with in obtaining certifications under the standards. The invention may be marketed as a new program that is available exclusively through the standards body 140. Vendor partners, e.g., materials suppliers and workers, provide products and services for a variety of structured cabling networks, such as for home automation, distributed audio and video, telephone, networking, lighting, security, testing equipment and heating, ventilation, and air conditioning (HVAC) control. The integrators may include a limited number of members in any given geographic territory that are provided with an opportunity to take advantage of sponsored training, specialized merchandising, cooperative promotions and web-based initiatives. Together with nationally recognized UL or similar certification, the vendors, integrators and products team can provide a nationally recognized solution for quality consumer electronic goods and services.

Various benefits of partnering with the standards body 140 may include recognition as a program partner in all promotional venues associated with the standards body 140, listing in all standards documentation materials, preferred treatment at the standards body's expos, home page recognition on the standards body's full service, e-commerce Web site, and product promotions at branches of the standards body, for instance.

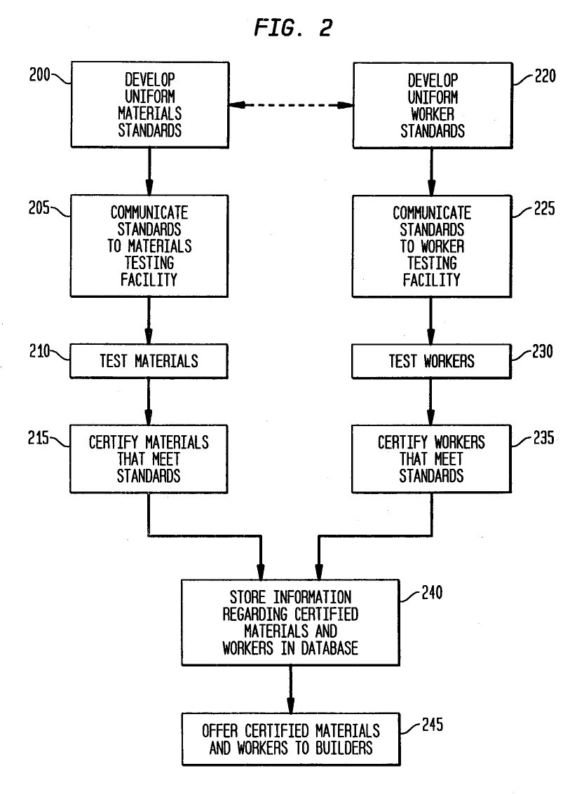

FIG. 2 illustrates a method for standardizing the quality of materials and services used in structured cabling networks. At blocks 200 and 220, respectively, uniform materials and worker standards are developed. This may be done by one or more entities, but there is generally coordination between these two processes because they are intertwined. At blocks 205 and 225, respectively, the materials and workers standards are communicated to the materials and testing facilities, e.g., electronically such as by e-mail, or as hardcopy documents by conventional mail. The standards body may periodically release updated and revised standards, e.g., to reflect new materials that are introduced, revised installation procedures, and the like. At blocks 210 and 230, respectively, the materials and workers are tested to determine if they meet the predefined criteria under the uniform standards provided by the standards body.

The predefined criteria may relate to safety, performance, ease of use, quality, durability, and other factors. For instance, a keypad controller for a home climate control system may be subject to repeated key presses to assess its longevity. The criteria might require that the keypad work properly after 10,000 presses in 10 minutes with 3-pound press force. Moreover, the controller may be subject to different temperatures, humidity levels and so forth. The criteria might require that the controller work properly after 10 hours in 110-degree temperature, at 90% humidity. A cable may be subject to strength tests to ensure it is not damaged when pulled or kinked. The cable may also be examined under a microscope to determine whether its structure is uniform. A signal-to-noise degradation of the cable may be tested. The impedance of the cable may also be tested for compliance. A maximum amount of attenuation for light passing through an optical fiber may be set. A door open sensor for a burglar alarm system may be subject to repeated cycles to ensure its reliability. The amount of electromagnetic radiation emitted from an electronic component may be tested to ensure it will not interfere with other electronic components in the network or home. Component temperatures can be tested to ensure they are not too high after prolonged operation. The effects of varying supply current to the electronic components, or loss of current, may be tested. Various other testing criteria may be developed as will be appreciated by those skilled in the art.

For worker testing, the criteria may define minimum test scores for various written tests on different subjects, as well as performance in hands on tests, such as installing a cable behind a wall with minimal damage to the wall, and under a time constraint.

At blocks 215 and 235, respectively, the materials and workers that pass the tests are certified under the uniform standards. Note that the standards need not necessarily be accepted throughout the industry. The certification may be provided as well by the standards body or other entity after the testing facilities provide information regarding the materials and workers that passed the tests. The certification generally may constitute a designation that the materials and workers have met the standards. For example, if UL is the materials testing facility, the materials may carry a symbol designating that they are UL approved, e.g., as a sticker, stamp or other designation on the materials themselves or on associated packaging or literature. Certified workers may be given an identification card that indicates their areas of certification and level of achievement, along with their name, address, and photo.

At block 240, information regarding the certified materials and workers is stored in a database, e.g., in the memory of a computer, for subsequent access in offering the materials and workers to builders, homebuyers and others (block 245). The information can be stored and accessed using any known hardware or software configuration or scheme. For example, the information may be accessible to the general public via the Internet. The builder, homebuyer or other interested party can enter information regarding their geographic location and type of building, for instance. In response, information regarding appropriate materials and workers can be provided. The builder or homebuyer may also schedule an appointment with the integrator or other party, request literature, and so forth. The integrator may access the database to obtain information for servicing the builder or homeowner, e.g., such as to develop a design plan for a structured cabling network with a list of materials and labor and associated costs.

The information in the database may be organized or classified according to various classifications of the certified materials, such as cabling, outlets, control devices, and test equipment, classifications of the services that the workers are available to provide, such as installation and design services, and classifications of building types for which the materials or workers have been certified, such as residences and light commercial buildings. Various other classifications may be made based on the various factors discussed herein.

Accordingly, it can be seen that the present invention provides a method and system for standardizing the delivery of structured cabling networks. The invention provides a value added systems integrator program, verified quality and performance of materials and workers by UL or other respected testing entity, key vendor partner participation and underwriting, and builder and consumer brand recognition. The invention provides many benefits, including: (a) a low voltage standard that is verified by UL or other entity for quality, performance and installation practices, (b) a new dealer program targeting current and future systems integrators, (c) a vehicle for the delivery of sponsored training by the standards body, merchandising, cooperative promotions and web based initiatives, (d) a limited key strategic vendor program adding value through the partnership, and (e) a brand to remember.

Moreover, various business strategies may be carried out regarding the different parties. For example, strategic goals for systems integrators include: (a) offer customers of the integrator a program built around the standards body's brand, (b) establish brand recognition and loyalty within the systems integrator's customer base, and leverage the brand to orchestrate long term meaningful relationships with designated customers of the systems integrator, (c) utilize training, technical support, merchandising, cooperative promotions and web based initiatives of the standards body as program tools, (d) promote the brand name and brand to low voltage and builder industry, (e) facilitate systems integrator and builder promotion into consumer segment, and (f) communicate UL or other entity verification/certification as value added by the standards body.

Vendor partner goals include: (a) increase the penetration of structured cabling and other low-voltage products within the new residential construction and light commercial markets, (b) increase overall installation value by leveraging the brand's value added, (c) cement the leadership role for the standards body's key strategic vendor partners, (d) create greater demand for the UL mark or other testing facility's mark, and (e) combat the commoditization of residential and light commercial structured cabling installation products.

Strategies for the standards body include: (a) create an awareness campaign on the benefits of the brand using expositions, e.g., conventions and trade shows, catalogs, mailings, Web and advertisements and other marketing vehicles, (b) create a systems integrator marketing program, based on training and purchasing commitments, and (c) create an incentive and training program targeting branch management and counter staff associated with the standards body to ensure long-term awareness and success. The standards body may further: (d) implement a merchandising strategy and roll out process within its top branches/offices, (e) create dedicated sales and marketing positions, (f) ensure all branches have sufficient product stock, product information, training and sales tools for the branded offerings, and (g) create a demo/model home and showroom program for systems integrators.

Goals for builders include: (a) initiate an awareness campaign on the benefits of the brand using builder magazines, tradeshows and other marketing vehicles, (b) create a marketing co-op fund for participating builders/developers to promote the brand's benefits, and (c) reward builder/developer participants through an annual award and recognition program.

Goals for consumers, e.g., home owners and buyers, include creating an awareness campaign using builder, systems integrator and web based marketing tools and some specialized marketing vehicles.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. A method for providing structured cabling networks in buildings in accordance with uniform quality standards, comprising:
defining uniform quality standards for materials for use in the structured cabling networks, and for workers for the structured cabling networks;
providing the uniform quality standards to at least one testing facility for use in: (a) certifying materials that are available from a plurality of suppliers based on testing that indicates the materials meet first predetermined criteria under the uniform quality standards, and (b) certifying workers that are available to provide services based on testing that indicates the workers meet second predetermined criteria under the uniform quality standards; and
offering the certified materials and certified workers for use in providing the structured cabling networks.

2. The method of claim 1, wherein the structured cabling networks comprise at least one of:
home automation networks, distributed audio networks, distributed video networks, telephone networks, computer networks, lighting networks, security networks, fire safety networks, and climate control networks.

3. The method of claim 1, wherein:
the materials comprise at least one of: cabling, outlets, control devices, and test equipment.

4. The method of claim 1, wherein:
the services that the workers are available to provide include installation of the certified materials in the structured cabling networks.

5. The method of claim 1, wherein:
the services that the workers are available to provide include design services which use the certified materials in the structured cabling networks.

6. The method of claim 1, wherein:
the certified materials and certified workers are offered for use in providing the structured cabling networks in accordance with a brand name that is associated with the uniform quality standards.

7. The method of claim 1, wherein:
the uniform quality standards include standards for new construction and retrofit structured cabling networks.

8. The method of claim 1, wherein:
at least some of the plurality of suppliers are substantially independent from one another.

9. The method of claim 1, wherein:
the materials are certified by an entity that is substantially independent from the plurality of suppliers.

10. The method of claim 1, wherein:
the uniform quality standards are defined by an entity that is substantially independent from an entity that certifies the materials.

11. The method of claim 1, wherein:
the workers are certified by an entity that is substantially independent from the workers.

12. The method of claim 1, wherein:
the buildings comprise at least one of residences and light commercial buildings.

13. A system for providing structured cabling networks in buildings in accordance with uniform quality standards, comprising:
at least one database for storing information regarding certified materials that are provided by a plurality of suppliers for use in the structured cabling networks, and regarding certified workers that are available to provide services for the structured cabling networks using the certified materials;
wherein the materials are certified based on testing that indicates the materials meet first predetermined criteria under the uniform quality standards, and the workers are certified based on testing that indicates the workers meet second predetermined criteria under the uniform quality standards.

14. The system of claim 13, wherein:
the information indicates classifications of the certified materials.

15. The system of claim 14, wherein:
the classifications of the certified materials include at least one of: cabling, outlets, control devices, and test equipment.

16. The system of claim 13, wherein:
the information indicates classifications of the services that the workers are available to provide.

17. The system of claim 16, wherein:
the classifications of the services include at least one of: installation of the certified materials in the structured cabling networks, and design services which use the certified materials in the structured cabling networks.

18. The system of claim 13, wherein:
the information indicates geographic areas in which the workers are available to provide their services.

19. The system of claim 13, wherein:
the information indicates at least one building type for which the materials have been certified.

20. The system of claim 13, wherein:
the information indicates at least one building type for which the workers have been certified.

21. The system of claim 13, wherein:
the buildings in which the structured cabling networks are provided comprise at least one of residences and light commercial buildings.

22. A method for providing materials and workers for structured cabling networks in buildings in accordance with uniform quality standards, comprising:
(a) certifying materials for use in the structured cabling networks that are available from a plurality of suppliers based on testing that indicates the materials meet first predetermined criteria under uniform quality standards; and
(b) certifying workers that are available to provide services for the structured cabling networks based on testing that indicates the workers meet second predetermined criteria under the uniform quality standards; and
providing information for offering the certified materials and certified workers for use in providing the structured cabling networks.
